(19) United States
(12) Patent Application Publication
(10) Pub. No.: US 2015/0364267 A1
(43) Pub. Date: Dec. 17, 2015

(54) PASSIVATED POROUS SILICON NANOWIRES

(71) Applicant: THE REGENTS OF THE UNIVERSITY OF CALIFORNIA, Oakland, CA (US)

(72) Inventors: Roya MABOUDIAN, Orinda, CA (US); John P. ALPER, Berkeley, CA (US); Carlo CARRARO, Orinda, CA (US)

(21) Appl. No.: 14/737,398

(22) Filed: Jun. 11, 2015

Related U.S. Application Data
(60) Provisional application No. 62/010,909, filed on Jun. 11, 2014.

(51) Int. Cl. H01G 11/36; H01G 11/86

(52) U.S. Cl. CPC H01G 11/36; H01G 11/86

(57) ABSTRACT

In exemplary embodiments, there is provided a scalable process for producing supercapacitor electrodes with very high specific capacitance and specific energy density, and very high capacitance retention after thousands of charge discharge cycles. The electrode material consists of a thin, electrically conductive carbon coating deposited onto nanoporous silicon nanowires. The coating prevents degradation of the silicon nanowires in aqueous solutions, while leaving the pore area fully accessible, enabling application as a supercapacitor electrode with the highest capacitance per projected area to date. The nanowires also are of use as a water splitting electrode and aqueous fuel cell electrode.

### CROSS REFERENCE TO RELATED APPLICATIONS

The present application claims priority under 35 U.S.C. §119(e) to U.S. Provisional Patent Application No. 62/010,909 filed Jun. 11, 2014, which is incorporated herein by reference in its entirety.

### STATEMENT OF GOVERNMENT RIGHTS

This invention was made with U.S. Government support under Grants Nos. EEC-0832819 (Center of Integrated Nanomechanical Systems) and DMR-1207053, awarded by the National Science Foundation. The Government has certain rights in the invention.

### BACKGROUND OF THE INVENTION

Supercapacitors function by storing electrical charge (Q) in the electrochemical double layer at the interface between an electrode and an electrolyte. When the electrode is biased with a potential V, ions of the opposite charge are electrostatically attracted to the electrode surface, forming the ECDL and leading to a capacitance, C, described by the standard parallel plate capacitor equation C=A/d∈¹. Here A is the interfacial area of the electrode, d is the distance between the electrode and the ECDL, and ∈ is the permittivity of the electrode-ECDL interphase. These devices are referred to as “super” capacitors in part because the electrodes are composed of materials with high specific surface area such as activated carbon² or exfoliated graphene³, and the distance between the electrode and ECDL is very small compared to standard capacitors; this leads to ˜100× greater specific capacitance over standard double plate capacitors⁴. Cycle lifetimes are typically orders of magnitude greater than battery electrodes as ideally there are no chemical reactions or volumetric changes within the active materials of supercapacitors during cycling⁵. Charge storage at the electrode surface also enables rapid charging and discharging characteristics and thus high power capabilities¹. Planar micro-supercapacitors refer to a class of supercapacitors utilizing planar electrode geometries with small form factors, preferable for on-chip application⁶. These supercapacitors are attractive energy storage devices for integration with autonomous micro-sensor networks due to their high-power capabilities and robust cycle lifetimes². Various methods have been used to fabricate carbon based planar micro-supercapacitors and single-electrode specific capacitances of up to ˜20 mF cm⁻² projected area have been achieved⁷.

EDLC devices are typically manufactured by encasing the electrodes and separator material in a package, usually an aluminum housing, which is wetted with electrolyte and sealed. The resulting device is a single cell EDLC device. These devices are used in a wide variety of applications including but not limited to industrial power supplies, UPS (uninterrupted power supplies), electric vehicles, cell phones, and in many electronic appliances.

The current generation of EDLCs operates with a nominal voltage rating of approximately 2.7 volts, a limitation imposed by virtue of the electrolyte. This requires that for many applications, many EDLC cells are required to meet the needs of a particular application. Except for devices that work at or below 2.7 volts, one or more EDLC devices are used in series to provide a composite device that operates at a higher voltage. For a specific application, a series-parallel configuration is often needed, but can include inherent problems. For example, as the number of cells increases in a series configuration, it is necessary to address cell balancing to prevent premature failure of the composite device. This approach is frequently expensive and cumbersome. The configurations are also large and heavy due to many individual cells used to form the composite structure.

Silicon-based supercapacitor electrodes synthesized via chemistries that are compatible with standard microfabrication processes are promising as on-chip power storage devices for autonomous microsystems applications due in part to their ease of integration with current microprocessor fabrication techniques. One such high surface area silicon synthesis method is based on a low temperature electroless etch process first described elsewhere^{8, 9}. This self-assembling synthesis method is well known to produce homogeneous arrays of porous silicon nanowires (PSiNW) with an average pore diameter of ˜10 nm and a high specific surface area of 342 m² g^{-1 10}. This is a large improvement in specific surface area over chemical vapor deposited silicon nanowires made porous by battery cycling (˜100 m² g⁻¹) previously reported as supercapacitor electrode materials¹¹ while utilizing a simpler one step wet etch. However, these porous nanowires are highly reactive and dissolve rapidly when exposed to mild saline solutions¹². Previously, silicon carbide (SiC) thin nanowires were used to protect the PSiNWs, yielding silicon carbide coated PSiNWs (SiC/PSiNWs)¹³. The SiC coatings were 10's of nm thick and, while they successfully mitigated Si degradation during electrochemical cycling in aqueous electrolytes, they also resulted in pore blockage and a large decrease in the materials' energy storage potential

In spite of extensive research and effort, making robust supercapacitors with high energy and power density still remains challenging. Supercapacitor electrodes of the prior art have not provided the device performance (e.g., energy density, power density, cycling stability, operating voltage) and manufacturability required for many high-performance, commercial applications. Thus, what is needed in the art is an improved supercapacitor based upon Si nanowires resistant to degradation during cycling, and with high energy storage potential. The present invention provides such Si nanowires, methods of making these nanowires and devices incorporating the nanowires.

### BRIEF SUMMARY OF THE INVENTION

It has now been discovered that the surface of Si-based nanowires can be passivated, imparting resistance to degradation during cycling, without substantially diminishing the energy density of the passivated nanowire in comparison to an identical unpassivated nanowire. In various embodiments, the present invention provides porous Si-based nanowires coated with an ultra-thin carbon sheath. The sheath incorporated into the wires of the invention allows full electrolyte access to the porous surface area while still mitigating Si degradation by electrolyte solutions.

Also provided is a method for forming the sheathed nanowires of the invention. Thus, in an exemplary embodiment, the Si nanowires are coated by treating with a dilute carbon source in an inert gas atmosphere at an elevated temperature. In an exemplary embodiment, the carbon source is dilute methane. In an exemplary embodiment, the inert gas is argon.

In an exemplary embodiment, the sheathed nanowires of the invention are incorporated into a device which benefits from reliable, robust power storage and discharge.

Other objects, advantages and embodiments of the invention will be apparent from the detailed description that follows.

### BRIEF DESCRIPTION OF THE DRAWINGS

FIG. 1A-FIG. 1E. A) SEM micrograph of porous Si nanowire array post carbonization. B) Representative STEM image of a PSiNW. C) Representative STEM image of a C/PSiNW. D) Silicon elemental mapping realized through energy filtered TEM image of a C/PSiNW. E) Carbon elemental mapping of the same nanowire as in D), realized through energy filtered TEM.

FIG. 2A.-FIG. 2B. A) High resolution TEM micrograph of a C/PSiNW. Red dotted lines outline non-crystalline edge region used to define combined carbon and residual native oxide coating on PSiNWs. B) Raman mapping of a C/PSiNW bundle. The Raman spectrum of a planar silicon region, which was also exposed to the carbonization conditions, is included (top curve), demonstrating the selectivity of the carbonization process for the more highly reactive PSiNW surface. SEM micrograph outset is the nanowire bundle being analyzed. Colored dots indicate locations where the Raman spectra were collected. The diameter of the colored dots represents 2 μm.

FIG. 3A.-FIG. 3B. A) Cyclic voltammograms obtained from porous silicon nanowire array, SiC/PSiNWs and C/PSiNWs in 3.5 M KCl at a scan rate of 50 mV s⁻¹. All nanowire arrays had lengths of ˜35 μm, achieved by matching the etching time. B) Plot of specific capacitance vs. average wire length for various CPSiNWs calculated from galvanostatic discharge data in EMIM-TFSI electrolyte at a current density of 1 mA cm⁻². Error bars are two standard deviations of the average value obtained from 10 cross sectional SEM images (representative SEM micrographs are inset for the different length arrays).

FIG. 4A.-FIG. 4C. A) Ragone plot comparing the energy and power density of the C/PSiNW device tested in this work to other planar micro-supercapacitor electrode materials: activated carbon (AC)¹⁷, inkjet printed carbon (IPC)¹⁶, laser written graphene (LWG)¹⁸, onion like carbon (OLC)¹⁷, reduced graphene oxide-carbon nanotube hybrid (RGO-CNT)⁷, silicon carbide coated porous silicon nanowires (SiC/PSiNW)¹³, silicon carbide nanowires (SiCNWs)¹⁹, and vapor-liquid-solid grown silicon nanowires (VLS-SiNW)²⁰. B) Results of extended cycling C/PSiNW device at charge-discharge current of 3 mA cm⁻². C) Photograph of C/PSiNW array device setup used to power a white LED during discharging of the device. The inset is an image of the LED during discharge.

FIG. 5. A schematic layout of the process to synthesize mesoporous silicon nanowires with a ˜1 nm carbon sheath (Scheme 1). Scanning electron micrograph at the lower left is image of carbonized nanowires with a 10 μm scale bar.

### DETAILED DESCRIPTION OF THE INVENTION

### I. Introduction

High surface area silicon-based electrodes synthesized via chemistries that are compatible with standard microfabrication processes are promising as on-chip power storage or generation devices for autonomous microsystems applications due to their ease of integration with current microprocessor fabrication technique and the intrinsic photoelectrochemical behavior of high surface area silicon. One such high surface area silicon synthesis method is based on a low temperature electroless etch process. This self-assembling synthesis method is known to produce homogeneous arrays of porous silicon nanowires. However, these porous nanowires are highly reactive and dissolve rapidly when exposed to mild saline solutions. As set forth herein, the present invention provides nanowire compositions, devices incorporating them and methods of making these compositions that solve this deficiency in the art by sheathing the porous nanowires with a passivating carbon coating.

Before the invention is described in greater detail, it is to be understood that the invention is not limited to particular embodiments described herein as such embodiments may vary. It is also to be understood that the terminology used herein is for the purpose of describing particular embodiments only, and the terminology is not intended to be limiting. The scope of the invention will be limited only by the appended claims. Unless defined otherwise, all technical and scientific terms used herein have the same meaning as commonly understood by one of ordinary skill in the art to which this invention belongs. Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention. Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number, which, in the context in which it is presented, provides the substantial equivalent of the specifically recited number.

It is noted that the claims may be drafted to exclude any optional element. As such, this statement is intended to serve as antecedent basis for use of such exclusive terminology as “solely,” “only,” and the like in connection with the recitation of claim elements, or use of a “negative” limitation. As will be apparent to those of skill in the art upon reading this disclosure, each of the individual embodiments described and illustrated herein has discrete components and features which may be readily separated from or combined with the features of any of the other several embodiments without departing from the scope or spirit of the invention. Any recited method may be carried out in the order of events recited or in any other order that is logically possible. Although any methods and materials similar or equivalent to those described herein may also be used in the practice or testing of the invention, representative illustrative methods and materials are now described.

In describing the present invention, the following terms will be employed, and are defined as indicated below.

### DEFINITIONS

“Nanoscale” as used herein has the following meaning; having one or more dimensions in the range 0.5 to 1000 nanometers.

“Nanowire” as used herein has the following meaning—a pathway which is electrically conducting substantially or entirely via ohmic conduction (as compared to tunneling conduction, for example). It is optionally other than a single linear form but may be direct, or indirect. It may also have side branches or other structures associated with it. The definition of nanowire may even include a film of particles which is homogeneous in parts but which has a limited number of critical pathways; it does not include homogeneous films of nanoparticles or homogeneous films resulting from the deposition of nanoparticles.

An exemplary “silicon nanowire” has a diameter, for example, within about 10 to about 500 nm. Silicon nanowires are any useful length. Exemplary lengths within about 0.5 to about 20 μm are of use. The diameter of the silicon nanowire may be measured via a cross-section that is cut perpendicularly with respect to the length of the silicon nanowire. For example, if the silicon nanowire has a hexagon-shaped cross-section, the cross-section may be measured as a length of a major axis (a line connecting corresponding vertices). The diameter and length of the silicon nanowire may be adjusted according to conditions of a manufacturing process, and the parameters of a device into which it is to be incorporated.

The terms “sensor” and “biosensor” are to be used interchangeably and are to be interpreted broadly to refer to an analytical device that is capable of converting a biological response into an electrical signal. The sensor or biosensor is capable of registering a change in an electrical property, e.g., when a target nucleic acid binds or hybridizes to a nucleic acid detection probe immobilized on the surface of a semiconductor nanostructure making up the sensor or biosensor.

A “super capacitor” is classified into three types in accordance with an electrode and a mechanism primarily used. The three types include (1) an electric double layer capacitor generally using activated carbon as an electrode and having charge absorption of an electrical double layer as a mechanism, (2) a metal oxide electrode pseudocapacitor (alternatively, redox capacitor) using transition metal oxide or conductive polymer as the electrode material and having pseudo-capacitance as the mechanism, and (3) a hybrid capacitor having a medium characteristic between the capacitors.

A basic structure of the super capacitor is constituted by a high surface area electrode, an electrolyte, a current collector, and a separator. The super capacitor has an electrochemical mechanism in which ions in electrolyte solution move on an electric field and adsorb on the surface of the electrode to store electrical energy by applying a voltage of several volts to both terminal of a unit cell as an operation principle.

An “electrochemical double layer capacitor” (EDLC) is an energy storage device consisting of two electrodes arranged in such a manner that one acts as the cathode and the other the anode, creating a structure that may be modeled as two capacitors in series. The device is characterized by a high power density whose value is dictated by the effective series resistance (ESR) of the device; the lower the ESR, the higher the power density. The capacitance of these devices is very large due to the high surface area of the electrode material and the spacing between the electrode and the molecules of the electrolyte that form the double layers. Indeed, an EDLC may be modeled as a conventional parallel plate capacitor using the effective surface area of the electrode material for the area and the molecular distance between the electrode and the electrolyte molecules as the spacing between the parallel plates.

“Capacitance” is calculated by the formula C=kA/d, where k is a constant of proportionality, A is the effective surface area, and d is the spacing between the plates.

The term “pseudocapacitor” refers to a device operating by an electrochemical reversible Faradaic redox reaction at a solid electrode of a conducting polymer or a metal oxide. The fast redox reaction gives the pseudocapacitor superior energy density but at a lower power density compared to an EDLC. See, e.g., I. H. Kim, et al., “Synthesis and Electrochemical Characterization of Vanadium Oxide on Carbon Nanotube Film Substrate for Pseudocapacitor Applications,” J. Electrochem. Soc., Vol. 153, No. 6 pp. A989-996 (2006); and Y. T. Kim, et al., “Highly dispersed ruthenium oxide nanoparticles on carboxylated carbon nanotubes for supercapacitor electrode materials,” J. Mater. Chem., Vol. 15, pp. 4914-4921 (2005).

The highest power density pseudocapacitor was constructed with hydrated ruthenium oxide (RuO₂) in a highly acidic sulfuric acid electrolyte. See J. P. Zheng et al., “Hydrous Ruthenium Oxide as an Electrode Material for Electrochemical Capacitors,” J. Electrochem. Soc., Vol. 142, No. 8, pp. 2699-2703 (1995); and C. C. Hu et al., “Effects of preparation variables on the deposition rate and physicochemical properties of hydrous ruthenium oxide for electrochemical capacitors,” Electrochimica Acta, Vol. 46, pp. 3431-3444 (2001).

However, the high cost of ruthenium and a desire to operate in a neutral electrolyte has positioned manganese oxide as a cost-effective solution. See M. Toupin et al., “Influence of Microstructure on the Charge Storage Properties of Chemically Synthesized Manganese Dioxide,” Chem. Mater., Vol. 14, pp. 3946-3952 (2002); and Y. U. Jeong et al., “Nanocrystalline Manganese Oxides for Electrochemical Capacitors with Neutral Electrolytes,” J. Electrochem. Soc., Vol. 149, No. 11, pp. A1419-A1422 (2002).

As used herein, a “pseudocapacitive material” refers to a material that can store energy through a reversible reduction/oxidation reaction on a surface thereof.

Pseudocapacitive materials include some metals and some metal oxides. The phenomenon of a pseudocapacitive material storing and releasing energy through the reversible reduction/oxidation reaction is referred to as “pseudocapacitance.” Pseudocapacitive materials include, but are not limited to, manganese oxide (MnO₂), ruthenium oxide (RuO₂), nickel oxide (NiO), and a combination thereof.

### The Embodiments

In various embodiments, the invention provides a porous silicon nanowire sheathed with carbon. The pores of the nanowire are accessible to an electrolyte with which the nanowire is in contact (e.g., operative contact). The nanowire of the invention is more resistant to degradation by aqueous electrolyte solutions compared to an identical unsheathed nanowire. Surprisingly, the carbon sheath over the porous silicon nanowire does not significantly diminish the energy density of the silicon nanowire.

The nanowires of the invention are porous. The total pore volume is sufficient to provide the desired level of ionic conductivity. Exemplary nanowires are from about 5% to about 20% porous. An exemplary nanowire of the invention is about 10% porous. In various embodiments, the invention provides porous nanowires that are less than about 10% porous. In various embodiments, the nanowires of the invention are more than about 25% porous, and can be more than about 50% porous, or more than about 75% porous, and even up to about 90% porous in some instances.

The nanowires of the invention can include mono- or multi-modal distribution of pore sizes of any useful range. The pores of the substrate can have any size. In an exemplary embodiment, the nanowires are microporous. An exemplary embodiment of a microporous nanowire includes pores of less than about 2 nm. The nominal pore size is typically measured in angstroms (10⁻¹⁰ m, Å). In one example, the average diameter of the pores is between about 1 and about 5000 Å. In another example, the volume average diameter of the substrate pores is between about 10 and about 5000 Å, between about 10 and about 4000 Å, between about 10 and about 3000 Å, between about 10 and about 2000 Å, between about 10 and about 1000 Å, between about 10 and about 800 Å, between about 10 and about 600 Å, between about 10 and about 400 Å, between about 10 and about 200 Å, between about 10 and about 100 Å, between about 20 and about 200 Å, between about 20 and about 100 Å, between about 30 and about 200 Å, between about 30 and about 100 Å, between about 40 and about 200 Å, between about 40 and about 100 Å, between about 50 and about 200 Å, between about 50 and about 100 Å, between about 60 and about 200 Å, between about 60 and about 100 Å, between about 70 and about 200 Å, between about 70 and about 100 Å, between about 80 and about 200 Å, between about 100 and about 200 Å, between about 100 and about 300 Å, between about 100 and about 400 Å, between about 100 and about 500 Å, between about 200 and about 500 Å or between about 200 and about 600 Å. In an exemplary embodiment, the pores are about 400 Å in diameter.

The specific surface area of the nanowire can be any useful dimension. In exemplary nanowires, the specific surface of the nanowire is from about 0.1 to about 2,000 m²/g. For example, the specific surface area of the nanowire is from about 1 to about 1,000 m²/g, from about 1 to about 800 m²/g, from about 1 to about 600 m²/g, from about 1 to about 400 m²/g, from about 1 to about 200 m²/g or from about 1 to about 100 m²/g. In another example, the specific surface area of the nanowire is from about 3 to about 1,000 m²/g, from about 3 to about 800 m²/g, from about 3 to about 600 m²/g, from about 3 to about 400 m²/g, from about 3 to about 200 m²/g or from about 3 to about 100 m²/g. In yet another example, the specific surface area of the nanowire is from about 10 to about 1,000 m²/g, from about 10 to about 800 m²/g, from about 10 to about 600 m²/g, from about 10 to about 400 m²/g, from about 10 to about 200 m²/g or from about 10 to about 100 m²/g.

As will be appreciated by those of skill in the art, the pore sizes set forth about can be varied and utilized in any combination to produce nanowires with the specific surface area set forth above. The values provided for pore size and surface area are combinable across all of the disclosed ranges.

Pore size distribution can be obtained using mercury intrusion analysis as is known in the art. In various embodiments, the pore size distribution is determined using standard procedures with samples of the oxide with an AutoPore Mercury Porosimeter.

In an exemplary embodiment, the invention provides a nanowire with an average pore diameter of ˜10 nm and a high specific surface area of 342 m² g⁻¹. This is a large improvement in specific surface area over chemical vapor deposited silicon nanowires made porous by battery cycling (˜100 m² g⁻¹) previously reported as supercapacitor electrode materials while utilizing a simpler one step wet etch. Previously, silicon carbide (SiC) thin nanowires were used to protect the PSiNWs, yielding silicon carbide coated PSiNWs (SiC/PSiNWs). The SiC coatings were 10's of nm thick and while they successfully mitigated Si degradation during electrochemical cycling in aqueous electrolytes, they also resulted in pore blockage and a large decrease in the materials' energy storage potential.

The present invention provides a method of sheathing a porous Si-based nanowire with a thin sheath of carbon. In an exemplary embodiment, the method comprises incubating the nanowire in an environment containing a dilute carbon source. In an exemplary embodiment, the carbon source is diluted with an inert gas. The incubation typically occurs at an elevated temperature and for a time sufficient to achieve a desired level of coating of the nanowire. In various embodiments, the carbon source is a gaseous hydrocarbon, e.g., methane. In an exemplary embodiment, the inert gas is argon.

The thickness of the carbon sheath is any useful thickness for a desired application. Methods set forth herein and generally known to those of skill in the art are available for assessing an appropriate thickness of the carbon layer, for example, to provide access to the pores in the silica nanowire by an electrolyte in contact with the nanowire, while providing a nanowire that is not appreciably degraded by the electrolyte.

In an exemplary embodiment, the carbon sheath is of a thickness sufficient to provide a retention of more than about 95%, more than about 90%, more than about 85%, more than about 80%, more than about 75% or more than about 70% of initial capacitance after a selected number of complete discharge cycles of a capacitor or pseudocapacitor comprising nanowires of the invention. In an exemplary embodiment, the number of complete discharge cycles is more than or equal to about 1,000, more than or equal to about 2,000, more than or equal to about 3,000, more than or equal to about 4,000, more than or equal to about 5,000 or more than or equal to about 10,000.

Exemplary sheath thicknesses range from about 0.1 nm to about 10 nm, e.g., from about 0.5 nm to about 5 nm, e.g., from about 1 nm to about 3 nm. In an exemplary embodiment, the thickness of the carbon layer is less than about 10 nm, e.g., less than about 5 nm.

Similarly, the length of the nanowires can be any useful length for a desired application. In an exemplary embodiment, the nanowires are from about a 1 μm to about 200 μm in length, e.g., from about 25 μm to about 120 μm in length.

In various embodiments, the nanowires of the invention are sheathed in a carbon coating that is essentially axially continuous along the long axis of the nanowire and also essentially radially continuous along the short axis of the nanowire. When the nanowire is essentially tubular, the nanowire is sheathed essentially continuously axially and circumferentially with carbon.

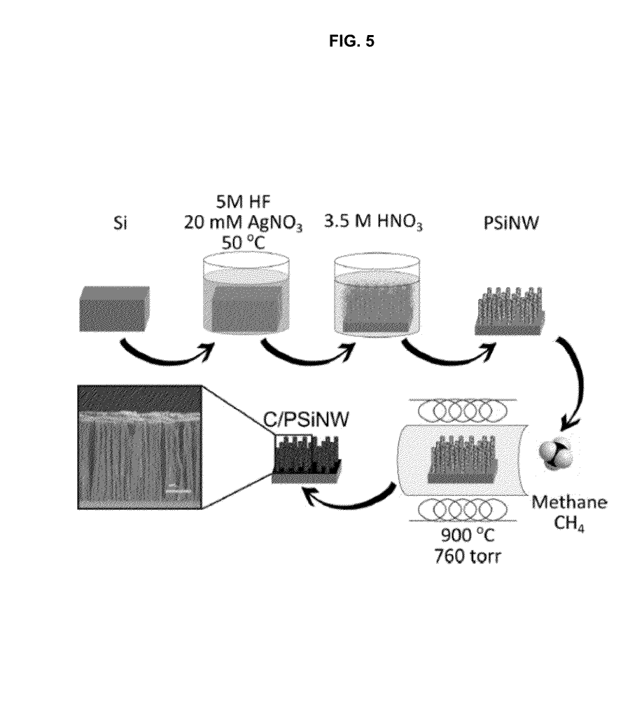

In an exemplary embodiment, a PSiNW array is incubated in a dilute methane environment in Ar at elevated temperatures deposits an ultra-thin (˜1-3 nm) carbon sheath over the nanowires. This allows for the first time full electrolyte access to the porous surface area while still mitigating Si degradation. A general schematic for the process steps are shown in Scheme 1 (FIG. 5). Specific capacitance values reaching 325 mF cm⁻² are achieved, representing the highest specific ECDL capacitance for planar micro-supercapacitor electrode materials to date. The materials are robust, with ˜83% capacitance retention after 5,000 complete charge discharge cycles in ionic liquid. These results are additionally novel as they indicate that the entirety of the carbon sheathed porous silicon nanowire structure is conformally coated, protected, and electrochemically active. Due to their high surface area, electro-chemical stability, and the ultrathin nature of the carbon coating, these materials are enabling to a variety of applications benefiting from high surface area, nanostructured Si based materials. Fuel cell energy generation, photoelectrolysis, and sensing are a few such non-limiting examples.

Supercapacitors (also known as ultracapacitors) have been attracting interest because they can instantaneously provide higher power density compared to batteries and higher energy density compared to the conventional dielectric capacitors. Such outstanding properties make them excellent candidates for applications in hybrid electric vehicles, computers, mobile electric devices and other technologies.

Generally, an electrochemical capacitor may be operated based on the electrochemical double-layer capacitance (EDLC) formed along an electrode/electrolyte interface, or a pseudocapacitance resulted from a fast reversible Faradaic process of material that undergoes Faradaic reactions (a “Faradaic material,” e.g., redox-active materials such as metal oxides and conductive polymers). In the present application, an EDLC-based capacitor is referred to as a double layer supercapacitor (DLS) and an electrode material coated onto a current collector in a DLS is referred to as a DLS material; a pseudocapacitance-based capacitor and/or one based on ion insertion is referred to as an electrochemical supercapacitor (ECS) and an electrode material coated onto a current collector in an ECS is referred to as an ECS material; an electrode material coated onto a current collector in a battery (e.g., Galvanic cell) is referred to as a battery material; “electrolyte” refers to the material which provides the ionic conductivity between supercapacitor electrodes; and “charge collector” refers to an electrically conducting material that connects the supercapacitor to an electronic circuit or other device(s).

For a DLS, the rapid charge/discharge process provides the capacitor with a high power density, yet the energy density is limited by its effective double-layer area. To date, a large number of DLS materials (e.g., high-surface-area materials, such as activated carbon, templated carbon, and carbon nanotubes (CNTs)) have been extensively studied. Activated carbons, with surface areas from 1000-2500 m²/g, are the most commonly used materials, which may provide a capacitance up to 320 F/g at low potential scanning rate. However, the capacitance may drop dramatically at high scanning rates because of their tortuous pore structure and high microporosity. The templated carbons, on the other hand, exhibit uniform pore geometry and larger pore size; however, they did not show any exciting improvement in either energy or power performance. For comparison, multi-walled CNTs show capacitances up to 135 F/g and single-wall CNTs show capacitances up to 180 F/g, which are still low for an actual device application.

Exemplary electrolyes of use in conjunction with the nanowires of the invention include organic electrolytes (e.g., solvents), salts and salt solutions, ionic liquids, polymer/gel electrolytes and a combination thereof (See, e.g., U.S. Pat. No. 8,520,365).

In an exemplary embodiment, the sheathed nanowires of the invention are a component of a pseudocapacitor. In such embodiments, the wires are treated with one or more pseudocapacitor composition that deposits into the pores of the nanowire, producing a pseudocapacitor. In various embodiments, the method provides for incorporating pseudocapacitive MnO₂ or one or more other pseudocapacitive composition through an electroless deposition process to provide an asymmetric supercapacitor architecture using an ionic liquid electrolyte.

In an exemplary embodiment, the pseudocapacitor includes less than or equal to about 50 mass %, less than or equal to about 40 mass %, less than or equal to about 30 mass %, less than or equal to about 20 mass % or less than or equal to about 10 mass % of the pseudocapacitive composition deposited on the silica nanowires.

In an exemplary embodiment, based on a 20 mass % MnO₂ pseudocapacitive electrode, a porous SiNW counter electrode, a 3 V potential window, and an active:inactive cell element ratio of 1:3, the invention provides a pseudocapacitor with an energy density of from about 100 to about 180 Wh kg⁻¹.

The pseudocapacitor of the instant invention provide an order of magnitude advance in specific energy storage in supercapacitor electrodes, with retention of demonstrated fast charge/discharge, time and cycling lifetime. Furthermore, the fabrication process of the present invention is highly scalable, which is desirable for low manufacturing costs. The device architecture and fabrication process are compatible with standard electronic device fabrication processes.

The nanowires of the invention are of use for various purposes and in various devices including, without limitation, microsupercapacitor electrode materials, fuel cell electrode materials, photoelectrochemical cell electrodes, water splitting materials and devices, sensor materials and devices, catalyst supports, and microfluidic catalysts.

In an exemplary embodiment, the nanowires of the invention are incorporated into a device configured for rapid charging of an electrical device, e.g., a mobile phone.

In an exemplary embodiment, the nanowires of the invention are incorporated into a transistor or other switching device.

In various embodiments, the nanowires of the invention form a component of a deposition control system.

In various embodiments, the nanowires of the invention are incorporated into a magnetic field sensor. Magnetic field sensors are required for a large number of industrial applications, e.g., as sensors for the magnetic information stored on a high density hard disk drive, or other magnetically stored information, where suitably small magnetic field sensors must be used as readheads. The principle is that the smaller the active component in the readhead, and the more sensitive, the smaller the bits of information on the hard drive can be, and the higher the data storage density.

In various embodiments, the nanowires of the invention are a component of a chemical sensor. A nanowire is useful for chemical sensors, and similar chemical sensitivity should be possible due to the response of the narrow wire formed in the narrowest part of devices of the invention. It is well established that very narrow wires, i.e. with nanometer diameters, whether exhibiting quantum conductance or not, can have their conductance modulated strongly by the attachment of molecules to the surface of the wire. This may result from wave function spillage or chemical modification of the surface of the wire. The strong modulation of the conductance of the wire can lead to high chemical sensitivity.

In various embodiments, the nanowires of the invention are incorporated into a temperature sensor.

In an exemplary embodiment, the nanowires of the invention are a component of a light emitting diode (LED) device.

An exemplary device of the invention is characterized by a useful degree of mechanical flexibility. Thus, the nanowires of the invention can be grafted to a flexible substrate. In an exemplary embodiment, the nanowires are fabricated on a graphene substrate and the nanowire/graphene assembly is later transferred to a flexible substrate, e.g., an organic polymer. See, e.g., Alper et al., Nanoscale, 2013, 5, 4114.

The invention is further illustrated by reference to specific examples set forth below. The examples are intended to illustrate selected embodiments of the invention and not to limit the scope of the invention.

### EXAMPLES

### Example 1

### Materials and Methods

Porous SiNWs were synthesized following the previously published method⁸. 1×1 cm² (1-5 mΩ·cm) silicon (100) coupons were cleaned by successive sonication in acetone, isopropyl alcohol and de-ionized water. The coupons were then exposed to UV generated ozone for 5 minutes and any silicon oxide was subsequently removed by a 5 minute etch in 48% hydrofluoric acid (HF). The unpolished sides of the samples were coated with a thin nylon coating in order to protect them from etching. A ˜2 mm wide strip of Si on the front side of the samples was also protected to provide an electrical contact point. Samples were then immersed in the oxidant/etchant bath consisting of 5M HF and 20 mM AgNO₃, equilibrated in a 50° C. heating bath, for various lengths of time to produce different length wire arrays. Samples were then rinsed in de-ionized water and residual silver was removed by a HNO3 (˜3.5M) etch for 15-45 minutes. Drying was performed in a critical point dryer (Tousimis Autosamdri815B). Carbonization was performed in an atmospheric pressure chemical vapor deposition chamber (Lindberg Blue/m). Samples were heated to 900° C. at a rate of ˜55° C. min−1 under 200 sccm of Ar (Praxair 99.995%). A flow of 4 sccm CH4 (Praxair 99.993%) was then introduced to the chamber for 30 minutes. The CH4 flow was then stopped and the sample cooled under Ar at a rate of ˜15° C. min⁻¹.

SEM imaging was performed using an Agilent 8500 FE-SEM at a beam voltage of 1 kV. TEM/STEM imaging was performed using a JEOL 2200FS Field-Emission microscope with in-column W filter, operated at 200 kV. Elemental maps were obtained by energy-filtering on the Si L and the C K edges. Raman spectroscopy was conducted with a HoribaJY LabRAM confocal Raman microscope utilizing a 633 nm laser. Electrochemical characterization was performed using a CHI 660D electrochemical station operating in a three-electrode configuration for single electrodes, and a two-electrode configuration for the device. For aqueous testing an Ag/AgCl reference and Pt wire counter electrode were used. Characterizations performed in EMIM-TFSI utilized an Ag wire reference and a Pt wire counter electrode. Contact angle measurements were made with a Ramé Hart 290-F1 automated goniometer.

### Results and Discussion

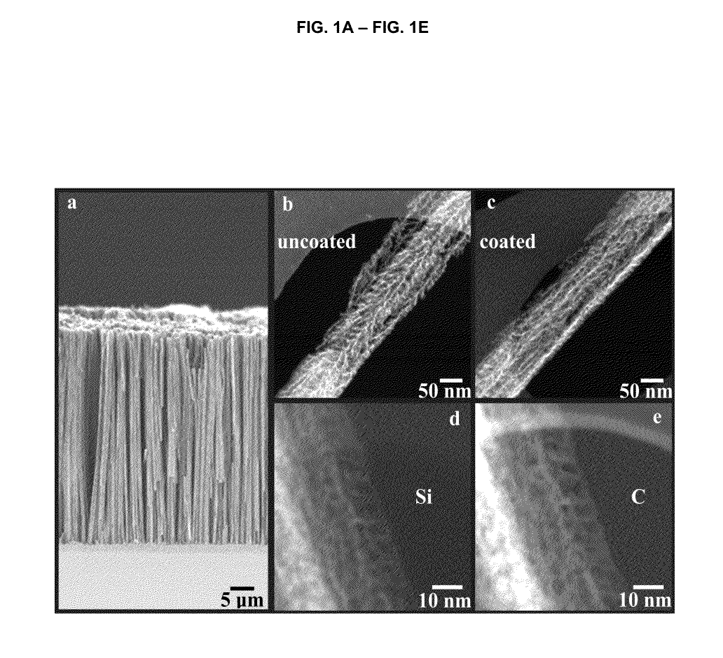

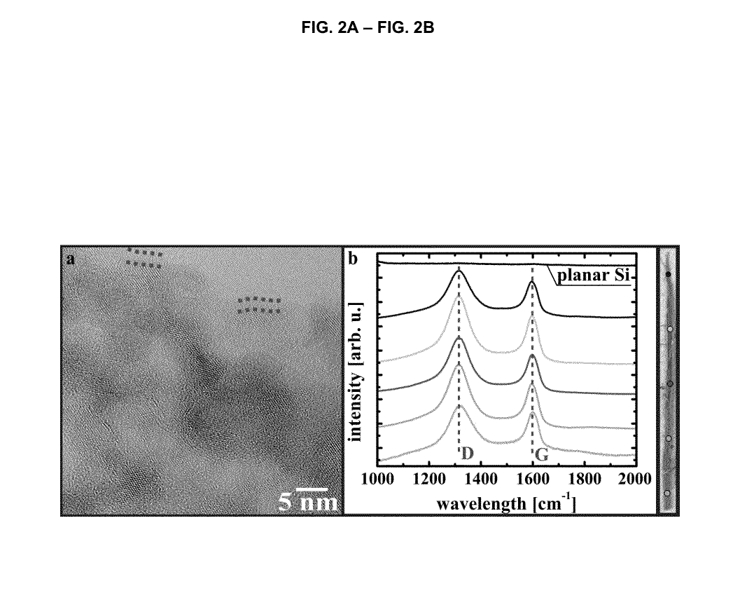

Scanning electron micrographs of the nanowires post carbonization (C/PSiNWs), as shown in FIG. 1A, reveal that their vertical orientation is maintained after carbonization and no significant structural damage is observed. A detailed transmission electron microscopy study was conducted in order to analyze the uniformity of the carbon sheath and the nanowire pore structure after carbon coating. A representative scanning transmission electron microscopy (STEM) analysis is presented in FIG. 1B, FIG. 1C for a nanowire pre-carbonization and a nanowire post-carbonization, respectively. The results indicate that the nanoscale pore structure of the PSiNWs is preserved, a key factor in realizing the full energy storage potential of these materials. Both the PSiNWs and C/PSiNWs samples exhibit a distribution of pore sizes; however, from these TEM images most openings are found to be ˜10 nm in diameter, showing close accordance with previous reports on the PSiNW pore structure 10. Elemental maps of C/PSiNWs generated from energy filtered TEM, shown in FIG. 1D, FIG. 1E, demonstrate complete overlap of the Si and C, which is important for successful passivation of the Si core. The pore openings also are clearly carbon free, strongly suggesting that the pore area remains solvent accessible. High resolution TEM micrographs of the C/PSiNWs (see FIG. 2A) indicate a crystalline core and an amorphous sheath as outlined in FIG. 2A. By analyzing the sheath thickness post carbonization, attributed to the carbon layer and residual native oxide, we estimate the carbon layer thickness to be between 1-3 nm. Micro-Raman measurements along a bundle of C/PSiNWs, presented in FIG. 2B, indicate the carbon sheath is axially continuous. The G peak position (1595-1596 cm⁻¹) and the D to G peak intensity ratios (1.34-1.42) both indicate a mainly sp² hybridized carbon nanowire¹⁴ with a correspondingly high electronic conductivity¹⁵. The lack of any carbon signal from the planar silicon exposed to the same carbonization conditions proves that the deposition chemistry is highly selective to the nanoporous form of silicon.

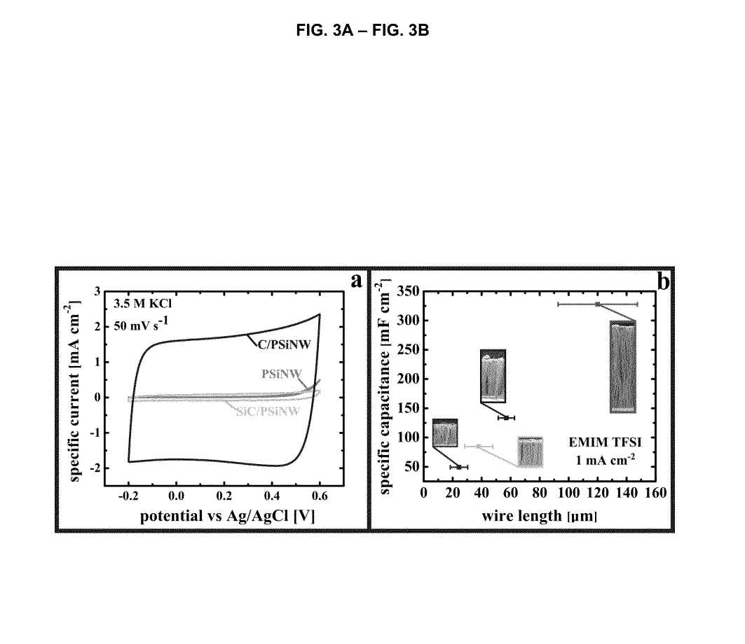

The capacitance characteristics of these materials are probed with the techniques of cyclic voltammetry (CV) and chronopotentiometry (CP) in a three-electrode configuration. In the former technique, the potential over the nanowire array is swept at a constant rate and the current is measured. During CP measurements, a constant current is applied to the nanowire array and the potential over it is measured. The specific capacitance ċ (mF cm⁻²) may be determined from either technique using the relationship:

$$C = t \cdot \frac{d t}{d V}$$

where i is the current density (A cm⁻²), and dV/dt is the scan rate (V s⁻¹). Both techniques have been performed in a three-electrode system to specifically analyze the electrode material's performance. In FIG. 3A, the CV results are presented in 3.5 M KCl for C/PSiNWs as well as PSiNWs and compared to those obtained previously for SiC/PSiNWs¹³. All nanowires were ˜35 μm in length, achieved by etching for the same amount of time. The large peak present in the PSiNW voltammogram near 0.8 V indicates oxidation of the PSiNWs¹³. The rapid degradation of the PSiNWs upon exposure to aqueous solutions also greatly reduces the electrically active surface area and hence the small capacitive current. The oxidation peak is greatly suppressed in the C/PSiNW results indicating passivation of the surface. The small residual peak may be due to the oxidation of the Si, the carbon surface, or the electrolyte and it indicates that the stability window for the entire system is ˜0.8V. The capacitive current measured on C/PSiNWs is ˜17× that measured for SiC/PSiNWs. This result confirms that the thin carbon sheath passivates the nanowire surface while leaving the pore volume more accessible to the electrolyte and resulting in the surface of the pore participating in capacitive energy storage. The carbon sheath's extremely thin nature is an important element in the improved performance, compared to the relatively thicker SiC coating which results in solvent exclusion from the pores and prevention of the pore surface from being an active capacitive site. A key finding is that capacitance in aqueous electrolytes slowly increases during cycling, due to slow infiltration of the water into the small, hydrophobic pores.

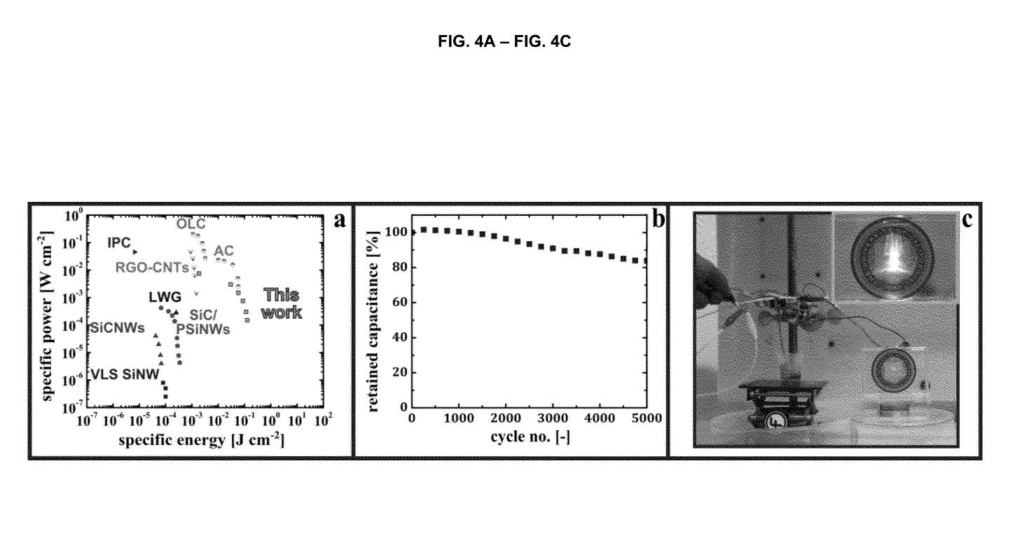

While mild aqueous electrolytes are attractive due to their environmentally benign nature, biocompatibility and low cost, the stable operating voltage window is limited to ˜1 V due to the electrolysis of water. In contrast, ionic liquids are stable over a much larger window, leading to improvements in the theoretical maximum energy and power densities, which scale with V². With this motivation, different length carbonized nanowire arrays (from 25 to 120 μm in length) were tested in an ionic liquid electrolyte, 1-ethyl-3-methylimidazolium bis(trifluoromethylsulfonyl)imide (EMIM-TFSI), and the scaling of capacitance with wire length was investigated. If the entirety of the wire is electrochemically active and wetted by the electrolyte, capacitance should scale linearly with nanowire length, as total surface area does. A near 0° contact angle was measured for EMIM-TFSI on the C/PSiNW surface, thus well wetted pores are expected. FIG. 4A presents the capacitance results from the chronopotentiometry testing of the nanowire arrays in EMIM-TFSI at a current density of 1 mA cm⁻² and a potential range of −1.0-1.7 V vs. Ag. These results demonstrate that the capacitance does indeed increase in a linear fashion with nanowire length. For arrays 120 μm in average length, a capacitance of ˜325 mF cm⁻² is obtained, the highest specific ECDL capacitance for planar electrode materials reported to date. This value corresponds well to the theoretical maximum expected for the uncoated porous SiNWs, confirming that the complete pore area is likely being utilized for charging; details of the calculation as well as the chronopotentiometry curves used to calculate the capacitance are understood by those of skill in the art. There are some observed charge transfer reactions from the non-ideal nature of discharge results. However they contribute negligibly to the calculated capacitance and robust cycle-lifetime results, discussed later, imply these reactions neither appreciably improve nor hinder performance. It is also found that the initial volumetric capacitance of the wires in EMIM-TFSI closely matches the maximum value measured in aqueous electrolytes during extended cycling, due to the excellent wettability of the carbonized C/PSiNWs by EMIM-TFSI.

In order to compare device performance metrics to other planar micro-supercapacitor electrode materials, two samples of C/PSiNWs, with specific capacitances of ˜75 mF cm⁻², were implemented in a planar device configuration utilizing EMIM-TFSI as the electrolyte. The energy density, E, is calculated from the chronopotentiometry results using:

E=½CV²

where V is the potential window. Power density is calculated from the CP results by P=E/t where t is the time to discharge. A Ragone plot comparing performance of a device of the invention to other planar micro-supercapacitor materials^{7, 13, 16, 17, 18, 19, 20} is presented in FIG. 4A. The C/PSiNW device exhibits energy densities in ionic liquids that are the highest published to date for planar supercapacitor electrode materials, while maintaining power densities which are comparable to carbon nanotube-reduced graphene oxide composites (RGO-CNT)⁷. This moderate power limitation is a result of the total ESR through the electrodes, ˜170Ω for a ˜0.8 cm² total device area, extrapolated from impedance spectroscopy results provided in the supplementary information. C/PSiNW lifetime behavior in EMIM-TFSI, shown in FIG. 4B, demonstrates that the materials are robust, with ˜83% capacitance retention after 5,000 complete CP cycles at a 3 mA cm⁻² charge discharge current. As a demonstration of the device function, FIG. 4C shows that it can successfully power a white LED.

The results presented highlight that C/PSiNWs are quite promising as an extremely high energy density planar micro-supercapacitor electrode material, which may enable smaller form factors for microsensors and microsystems devices. These results are also interesting as they indicate that the entirety of the porous structure is conformally coated, protected, and electrochemically active. Due to their high surface area, electro-chemical stability, and the ultra-thin nature of the carbon coating, these materials may very well prove enabling to a variety of applications benefiting from high surface area, nanostructured Si based materials. Fuel cell energy generation²¹, photoelectrolysis²², and sensing²³ are a few such examples.

It will be appreciated from the foregoing that the present invention may be employed in not only supercapacitor applications, but in other applications as well (e.g., batteries, battery-type supercapacitors, etc.). Furthermore, although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

### REFERENCES

1. Conway, B. E. Electrochemical Supercapacitors: Scientific Fundamentals and Technological Applications; Springer: New York, N.Y., 1999.
2. Simon, P.; Gogotsi, Y. Materials for Electrochemical Capacitors. Nature Materials 2008, 7 (11), 845-854.
3. Zhu, Y.; Murali, S.; Stoller, M. D.; Ganesh, K. J.; Cai, W.; Ferreira, P. J.; Pirckle, A.; Wallace, R. M.; Cychosz, K. A.; Thommes, M.; Su, D.; Stach, E. A.; Ruoff, R. S. Carbon based supercapacitors produced by activation of graphene. Science 2011, 332, 1537-1541.
4. Winter, M.; Brodd, R. J. What are Batteries, Fuel Cells and Supercapacitors? Chemistry Reviews 2004, 104 (10), 4245-4269.
5. Frackowiak, E.; Beguin, F. Carbon materials for the electrochemical storage of energy in Capacitors. Carbon 2001, 39, 937-950.
6. Chmiola, J.; Largeot, C.; Taberna, P.-L.; Simon, P.; Gogotsi, Y. Monolithic Carbide-Derived Carbon Films for Micro-Supercapacitors. Science 2010, 328, 480-483.
7. Beidaghi, M.; Wang, C. Micro-Supercapacitors Based on Interdigital Electrodes of Reduced Graphene Oxide and Carbon Nanotube Composites with Ultrahigh Power Handling Performance. Advanced Functional Materials 2012, 22 (21), 4501-4510.
8. Peng, K.-Q.; Yan, Y.-J.; Gao, S.-P.; Zhu, J. Synthesis of Large Area Silicon Nanowire Arrays via Self-Assembling Nanoelectrochemistry. Advanced Materials 2002, 14 (16), 1164-1167.
9. Zahedinejad, M.; Khaje, M.; Erfanian, A.; Raissi, F. Successful definition of nanowire and porous Si regions of different porosity levels by regular positive photoresist using metal-assisted chemical etching. Journal of Micromechanics and Microengineering 2011, 21, 065006.
10. Hochbaum, A. I.; Gargas, D.; Hwang, Y. J.; Yang, P. Single Crystalline Mesoporous Silicon Nanowires. Nano Letters 2009, 9 (10), 3550-3554.
11. Choi, J. W.; McDonough, J.; Jeong, S.; Yoo, J. S.; Chan, C. K.; Cui, Y. Stepwise Nanopore Evolution in One-Dimensional Nanostructures. Nano Letters 2010, 10, 1409-1413.
12. Chiappini, C.; Liu, X.; Fakhoury, J. R.; Ferrari, M. Biodegradable Porous Silicon Barcode Nanowires with Defined Geometry. Advanced Functional Materials 2010, 20 (14), 2231-2239.
13. Alper, J. P.; Vincent, M.; Carraro, C.; Maboudian, R. Silicon Carbide Coated Silicon Nanowires as Robust Electrode Material for Aqueous Micro-Supercapacitor. Applied Physics Letters 2012, 100 (16), 163901.
14. Ferrari, A. C.; Robertson, J. Interpretation of Raman spectra of disordered and amorphous carbon. Physical Review B 15, 14097-14106.
15. Grill, A. Electrical and Optical Properties of Diamond Like Carbon. Thin Solid Films 1999, 355-356, 189-193.
16. Alper, J. P.; Kim, M. S.; Vincent, M.; Hsia, B.; Radmilovic, V.; Carraro, C.; Maboudian, R. Silicon Carbide Nanowires as Highly Robust Electrodes for Micro-Supercapacitors. Journal of Power Sources 2013, 230, 298-302.
17. Pech, D.; Brunet, M.; Taberna, P.-L.; Simon, P.; Fabre, N.; Mesnilgrente, F.; Conédéra, V.; Durou, H. Elaboration of a microstructured inkjet-printed carbon electrochemical capacitor. Journal of Power Sources 2010, 195 (4), 1266-1269.
18. Thissandier, F.; Le Comte, A.; Crosnier, O.; Gentile, P.; Bidan, G.; Hadji, E.; Brousse, T.; Sadki, S. Highly Doped Silicon Nanowires Based Electrodes for Micro-Electrochemical Capacitors Applications. Electrochemistry Communications 2012, 25, 109-111.
19. Gao, W.; Singh, N.; Song, L.; Liu, Z.; Reddy, A. L. M.; Ci, L.; Vajtai, R.; Zhang, Q.; Wei, B.; Ajayan, P. M. Direct laser writing of micro-supercapacitors on hydrated graphite oxide films. Nature Nanotechnology 2011, 6 (8), 496-500.
20. Goodey, A. P.; Eichfeild, S. M.; Lew, K.-K.; Rewing, J. M.; Mallouk, T. E. Silicon Nanowire Array Photoelectrochemical Cells. JACS Communications 2007, 129, 12344-12345.
21. Lewis, S. E.; DeBoer, J. R.; Gole, J. L.; Hesketh, P. J. Sensitive, selective, and analytical improvements to a porous silicon gas sensor. Sensors and Actuators B 2005, 110, 54-65.
22. Pech, D.; Brunet, M.; Durou, H.; Huang, P.; Mochalin, V.; Gogotsi, Y.; Taberna, P.-L.; Simon, P. Ultrahigh-power micrometre-sized supercapacitors based on onion-like carbon. Nature Nanotechnology 2010, 5 (9), 651-654.
23. Wang, M.; Wang, X.; Li, J.; Liu, L. In situ synthesis of 3D platinum nanoflowers on porous silicon for monolithic integrated micro direct methanol fuel cells. Journal of Materials Chemistry A 2013, 1, 8127-8133.

What is claimed is:

1. A passivated porous silicon nanowire comprising a conductive silicon interior sheathed in a carbon layer, wherein said silicon nanowire has a long axis and a short axis and said layer essentially fully sheaths said nanowire along both said long axis and said short axis, said carbon layer configured to allow access to pores in said nanowire by an electrolyte in contact with said nanowire and providing said nanowire with a degradation rate by said electrolyte less than that of an identical nanowire in the absence of said carbon layer.

2. The passivated porous silicon nanowire according to claim 1, wherein said nanowire further comprises one or more pseudocapacitive composition deposited.

3. The passivated porous silicon nanowire according to claim 1, wherein said nanowire is from about 25 μm to about 120 μm in length.

4. The passivated porous silicon nanowire according to claim 1, wherein said carbon layer is from about 0.5 to about 5 nm in thickness

5. The passivated porous silicon nanowire according to claim 1, wherein the porous silicon comprises pores having an average diameter of from about 5 nm to about 15 nm.

6. A plurality of said passivated porous silicon nanowires according to claim 1, wherein each of said nanowires is anchored to a substrate.

7. A plurality of said passivated porous silicon nanowires according to claim 1, wherein each of said nanowires is anchored to a substrate, which is a mechanically flexible substrate.

8. A plurality of said passivated porous silicon nanowires according to claim 1, wherein each of said nanowires is anchored to a substrate with a spacing between said nanowires of from about 80 nm to about 120 nm.

9. A plurality of said passivated porous silicon nanowires according to claim 1, wherein each of said nanowires is anchored to a substrate, wherein said plurality of nanowires is in operative contact with an electrolyte solution.

10. A method of manufacturing a passivated porous silicon nanowire according to claim 1, said method comprising: (a) incubating an unpassivated precursor silica nanowire in an atmosphere comprising a dilute carbon source, said incubating occurring for a time and at a temperature appropriate to sheath said precursor porous silicon nanowire in said carbon layer, thereby forming said passivated, porous silica nanowire.

11. The method according to claim 10, wherein said carbon source is a gaseous hydrocarbon.

12. The method according to claim 11, wherein said carbon source is a methane.

13. The method according to claim 10, wherein said carbon source is diluted with an inert gas.

14. The method according to claim 13, wherein said inert gas is argon.

15. A device comprising a passivated, porous silicon nanowire according to claim 1.
